(19) United States
(12) Patent Application Publication
(10) Pub. No.: US 2026/0344648 A1
(43) Pub. Date: Nov. 5, 2026

(54) Humane rodent repellent using scent to deter rodents

(71) Applicant: Bernie C Thompson, Tijeras, NM (US)

(72) Inventor: Bernie C Thompson, Tijeras, NM (US)

(21) Appl. No.: 19/738,493

(22) Filed: Jul. 12, 2026

Related U.S. Application Data
(63) Continuation of application No. PCT/US24/62204, filed on Dec. 28, 2024.
(60) Provisional application No. 63/630,246, filed on Jan. 16, 2024.

(51) Int. Cl. A01M 29/12; A01N 27/00; A01N 37/02; A01P 17/00

(52) U.S. Cl. CPC A01M 29/12; A01N 27/00; A01N 37/02; A01P 17/00

(57) ABSTRACT

The present invention provides methods and apparatuses that allow rodents to be humanely and safely repelled from places where humans do not want such rodents, using specific apparatuses and chemicals such as pentyl acetate, y-terpinene, and p-cymene.

### FIELD OF INVENTION

The invention relates to the field of non-lethal repelling of rodents, specifically non-lethal chemicals, methods, and systems that repel rodents by scent.

### BACKGROUND

There have been unwanted rodents living with humans for thousands of years. Over time there have been countless ways humans have tried to kill and deter rodents, from the use of mechanical traps to chemicals. A widely used chemical acts as an anticoagulant which, when ingested, allows the rodent to bleed to death. These can be very effective but always pose secondary poisoning to other animals. Furthermore the rodent once killed can decay in places not easily accessed to remove it, thus a horrible smell (putrefaction) can linger for some time. Yet other chemicals have been used to fumigate such rodents but pose risks not only to the rodents but to the users as well. And once again the rodent once killed can decay in a place not easily accessed to remove it, thus a horrible smell can linger for some time.

Repelling rodents non-lethally is a benefit because the rodent is not incentivized to enter where they are not wanted, such as baits which actually draw rodents to enter where they are not wanted. Conventional rodent controls such as baits, poisons, and traps can cause dead rodents to die and decay in unwanted places such as in houses, sheds, cars, trucks, motor homes, and/or vehicles. The inventor tested chemicals publicized for repelling rodents, e.g., mint oil and others. The mint oil and other chemicals used had no effect on the rodents in an open air feeding station environment. The main testing was conducted in open air feeding stations, and on vehicles that were parked for extended time periods.

What is needed is chemicals, methods, and systems that will produce consistent results where the rodent will leave under its own power and not return.

### SUMMARY OF THE INVENTION

The present invention provides a non-lethal chemical which repels rodents, keeping them away from areas where they are not wanted. Therefore rodents do not die and decay in unwanted places such as in houses, sheds, cars, trucks, motor homes, and/or vehicles. When tested in similar conditions as conventional repellants, the present invention produced superior results in keeping rodents such as these away from places that humans do not want them. Testing was carried out with an open air feeding station that incorporated cameras. The chemicals, methods, and systems described herein worked well to deter rodents (mice, rats, and squirrels). The main testing was conducted in open air feeding stations, and on vehicles that were parked for extended time periods. It was found through testing that rodents that had made permanent nests in vehicles would leave and not return as long as the chemical scent was present. Further testing on prairie dogs, gophers and squirrels was also conducted, where unwanted prairie dog, gopher, and squirrel holes existed. The chemical was placed in the hole and covered and no hole was subsequently uncovered by the rodents. It is a very difficult task to move prairie dogs from their homes; however the preferred chemicals worked well to accomplish moving the rodent from where they were unwanted. Testing with closed air environments were found to be more effective in repelling rodents than with open air testing, thought to be due to higher chemical density ratios. The chemicals described herein can be derived from all-natural plant based substances which are environmentally friendly and poses no health risks for humans or pets.

The present invention allows rodents to be humanely and safely repelled from places where humans do not want such rodents. This is accomplished using chemicals that have been overlooked for this purpose. Chemicals useful in the present invention include pentyl acetate and amyl acetate or the like. These chemicals produce a scent described as a “banana-like odor” and can be used to repel such rodents. These chemicals carry a unique scent that rodents do not like. However pentyl acetate has a very strong scent that bothers some humans so it has been found that if the pentyl acetate is mixed with camphene and/or 3-carene it reduces its strong smell. An example mixture that was found by the inventors to be effective is a 50 percent pentyl acetate and 50 percent camphene (by volume). This mixture has been found to repel rodents while mitigating the scent that humans dislike. A higher percent by volume of pentyl acetate can be more effective for rodent repellant. Further testing produced results that were unexpected, such as if any two or more chemicals are used whether mixed or used pure, they lose their effectiveness to repel rodents. So testing began to find a single pure chemical that would work where humans do not have a poor reaction to the scent, but would repel rodents. Out of multiple chemicals tested two chemicals stood out from all other chemicals and worked amazingly well using these parameters. These two chemicals are y-terpinene and p-cymene. When these chemicals are used in their pure form they have a lower odor for humans but repel rodents much better than pentyl acetate. In some tests, y-terpinene provided better results. A basic and novel characteristic of the present invention is that each of pentyl acetate, y-terpinene, and p-cymene provides this improved repelling effect when used as a single chemical; the presence of any additional rodent-repelling chemical materially affects, and reduces, this repelling effect.

None of these chemicals described for the invention have ill effects to humans or pets. Both example chemicals y-terpinene, and p-cymene are natural plant based products. They are all harmless to humans, thus presenting no obstacles to having them present to repel rodents where humans or pets live.

### BRIEF DESCRIPTION OF THE DRAWINGS

FIG. 1 is a drawing of a plastic holding tube with coiled saturated candle wick rope.

FIG. 2 is a drawing of a plastic holding tube with coiled saturated candle wick rope inside, illustrated with additional extended chemical drip system.

FIG. 3 is a drawing of a vinyl hose with evenly cut vents, with saturated candle wick rope inside.

FIG. 4 is a drawing of a vinyl tubing with evenly cut vents and saturated candle wick rope inside, illustrated with additional extended chemical drip system.

### DESCRIPTION OF THE INVENTION

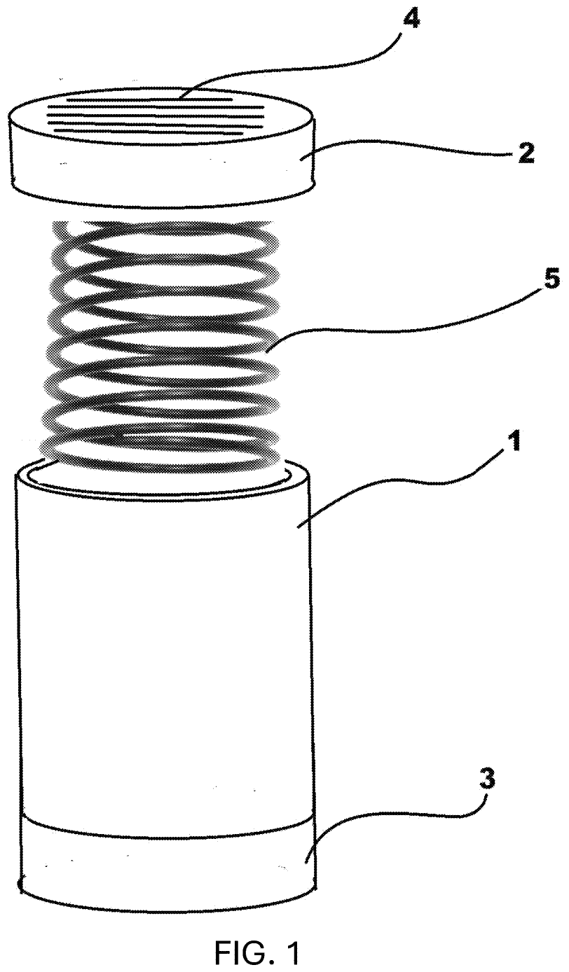

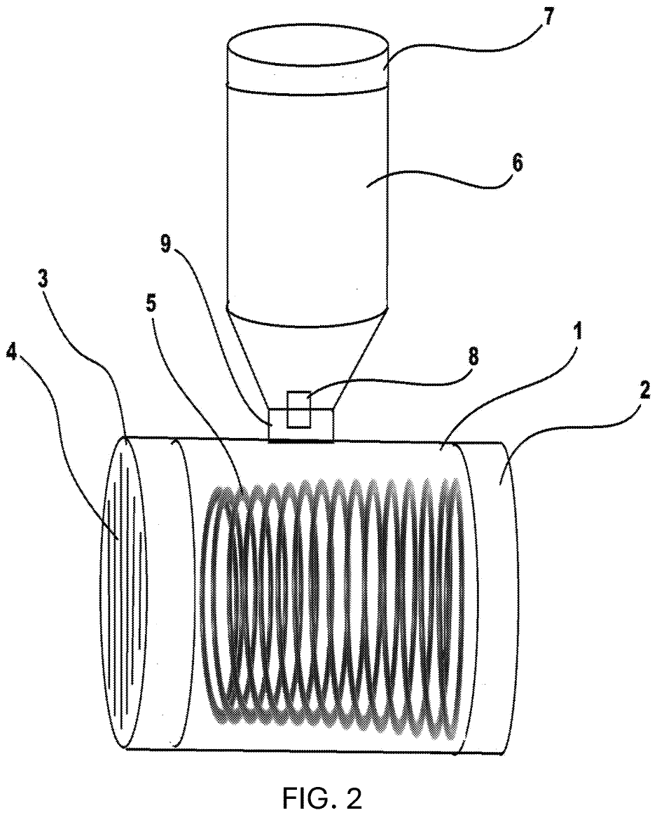

The present invention can use pentyl acetate, y-terpinene, and p-cymene. Since the chemicals pentyl acetate, y-terpinene, and p-cymene are flammable, they must be used in a way to reduce their flammability. The present invention provides methods and systems that mitigate the flammable nature of these chemicals while allowing the scent to freely move away from the source. As an example, the chemical can be allowed to saturate an absorbent material that is placed inside a closed space with vents that allow the chemical scent to reach the surrounding area. Other methods of allowing the chemical scent to reach the surrounding area can also be suitable. An example method and system is shown in FIG. 1. A cotton rope (e.g., ⅛ inch candle wick rope or the like) is saturated with the chemical to be used and disposed into an approximately 1 inch PET hard plastic tube (1) or the like with no vents. The tube has thread-on end caps (2)(3) that screw on to tube (1). End caps (2)(3) have small opening (vents) (4) in them that will allow the chemical scent to reach the surrounding area. In order to provide a strong scent for a longer period of time it has been found the candle wick rope or the like can be coiled (5) into the tube allowing more surface area with chemical on it, thus allowing a longer lasting deterring scent to be produced. This method produces a very high chemical ratio density within the tube or closed area with vents. It has been found that with the use of this high density chemical ratio method, the scent within the saturated rope will last quite well for over a month of time in open air. This is much longer than when using cotton balls, cotton gauze, or cotton cloth methods. Additionally a chemical reservoir can be added if longer protection is needed, as illustrated in FIG. 2. Reservoir (6) is used to store additional chemical. The additional stored reservoir chemical can be 20 cc to 100 cc or larger, depending on the level and duration of protection needed. Air tight lid (7) is used to seal the reservoir. Reservoir (6) threads into Hard Plastic tube (1) at (9). This allows new extra chemical to be changed out quickly. Metering jet (8) is used to slowly drip chemical on to Candle wick rope (5) since this is a wicking material the chemical is moved throughout the rope. Metering Jet (8) can be 0.002, 0.004, 0.006, or 0.008 thousandths of an inch, or the like, as examples. These jet sizes can be configured responsive to the level and duration of protection that will be needed. The larger the jet the quicker the liquid is used keeping the candle wick rope saturated. Since the reservoir is air tight the liquid chemical slowly drips due to a pressure differential (vacuum) created from chemical loss or drip.

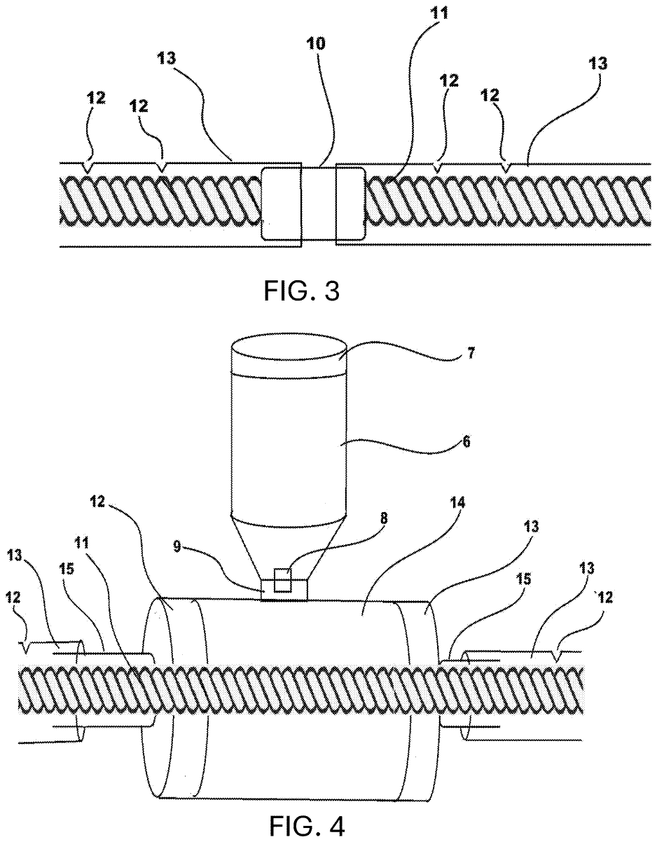

Another example embodiment of the invention is illustrated in FIG. 3, where a cotton rope (or similar, as discussed above) (11) with chemical is disposed inside a vinyl hose (13) or the like that has small openings (12) (vents) cut evenly along the hose or the like. The ends of the vinyl hose (13) are connected together at hose union (10) in order to provide a closed ring of protection or boundary whereas rodents are repelled. This closed ring is also referred to herein as a closed loop, in which a first end and a second end of the flexible tube are joined together by the hose union. Additionally the hose can have end plugs and be made for use without a loop. Thus basically a straight hose that can be laid however is needed for a boundary of rodent protection. When longer protection periods of time are needed, a chemical reservoir can be used, as illustrated in FIG. 4. Reservoir (6) is used to store addition chemical, additional stored reservoir chemical can be 20 cc to 100 cc or larger, depending on the level of protection needed, air tight lid (7) is used to seal reservoir (6). Hard plastic tube (14) is used to hold candle wick rope (11) and allows reservoir (6) to be threaded onto tube (14) At threaded connection (9) metering jet (8) is used to slowly drip chemical on to candle wick rope (11); since this is a wicking material the chemical is moved throughout the rope. Tube cap ends (12)(13) thread onto hard plastic tube (14) and have vinyl hose connections (15). Metering jet (8) can be 0.002, 0.004, 0.006, or 0.008 thousandths of an inch, or the like, as examples. These jet sizes can be determined depending on the level of protection that will be needed. The larger the jet the quicker the liquid is used keeping the candle wick rope saturated. Since reservoir (6) is air tight liquid chemical is slowly dripped due to a pressure differential (vacuum) created from chemical loss or drip. Cotton rope is used for candle wick or the like, thus, will wick the chemical throughout the cotton rope (11). If needed multiple chemical reservoirs can be incorporated on the same hose. Another method is to take this vinyl tube (13) or conduit or the like that has small openings (12) evenly cut into it and place it around what needs to be protected from rodents. As examples, but not limited to, this structure can be laid on the ground around a vehicle tire, vehicle, motorhome, shed, or the like. Through testing it has been determined that mice and rats will not cross this boundary, therefore repelling rodents before they get into somewhere humans don't want them to be. The rodents will not cross this boundary thus preventively protecting the object from rodents. Additionally hard plastic tubes as in FIG. 1 can be put in the vehicle, motorhome, shed, or the like to create additional protection from rodent invasions.

The invention shown above is the culmination of years of research and development. Whereas the drawing and accompanying description have shown and described example embodiments of the present invention, it should be apparent to those skilled in the art that various changes may be made in the forms and uses of the inventions without affecting the scope thereof.

What is claimed is:

1. An apparatus that repels rodents, comprising: (a) a container having a space inside and having one or more vents that allow gas communication between the inside and outside of the container; (b) a wick, saturated with a rodent-repelling chemical disposed within the container, wherein the rodent-repelling chemical consists essentially of one chemical selected from the group consisting of pentyl acetate, amyl acetate, y-terpinene, and p-cymene.

2. The apparatus of claim 1, wherein the container comprises a tube having a removable end cap at a first end of the tube, where the tube, with the end cap removed, can accommodate insertion of the wick, application of chemical to a wick inside the tube, or a combination thereof.

3. The apparatus of claim 2, wherein the tube has no vents, and wherein the end cap has one or more vents.

4. The apparatus of claim 1, wherein the container comprises a flexible tube.

5. The apparatus of claim 4, wherein the flexible tube has sufficient length to encompass a region to be protected against rodents, and has a plurality of vents disposed along the entire length of the flexible tube.

6. The apparatus of claim 1, further comprising a fluid reservoir, mounted with the container such that a fluid within the reservoir is dispensed to the wick.

7. The apparatus of claim 6, wherein the reservoir has a metering jet that controls dispensing of a chemical in the reservoir to the wick.

8. The apparatus of claim 7, wherein the metering jet is an orifice having a diameter of 0.002, 0.004, 0.006, or 0.008 thousandths of an inch.

9. The apparatus of claim 8, wherein the reservoir contains a quantity of the rodent-repelling chemical.

10. A method of repelling rodents from a region, comprising providing an apparatus as in claim 1, then placing the apparatus in communication with the region.

11. The method of claim 10, wherein the container comprises a tube having a removable end cap at a first end of the tube, and wherein providing the apparatus comprises removing the end cap, inserting the wick into the tube, saturating the wick with the rodent-repelling chemical, and replacing the end cap on the tube, prior to placing the apparatus in communication with the region.

12. The method of claim 10, wherein the apparatus further comprises a fluid reservoir mounted with the container such that a fluid within the reservoir is dispensed to the wick, and wherein providing the apparatus comprises supplying the rodent-repelling chemical to the reservoir prior to placing the apparatus in communication with the region.

13. The method of claim 10, wherein the container comprises a flexible tube having sufficient length to encompass a region to be protected against rodents and having a plurality of vents disposed along the entire length of the flexible tube, and wherein placing the apparatus in communication with the region comprises disposing the flexible tube about a circumference of the region.

14. The apparatus of claim 1, wherein the chemical is pentyl acetate.

15. The apparatus of claim 1, wherein the chemical is y-terpinene.

16. The apparatus of claim 1, wherein the chemical is p-cymene.

17. The apparatus of claim 1, wherein the chemical is amyl acetate.

18. The apparatus of claim 1, wherein the wick is coiled within the space inside the container to increase the surface area of the wick exposed within the container.

19. The apparatus of claim 4, wherein the flexible tube comprises a vinyl hose.

20. The apparatus of claim 5, wherein a first end and a second end of the flexible tube are connected together by a hose union, thereby forming a closed loop that defines a boundary about the region to be protected.
